(19) United States
(12) Patent Application Publication
(10) Pub. No.: US 2025/0058857 A1
(43) Pub. Date: Feb. 20, 2025

(54) HULL STRUCTURE FOR A SEMI-SUBMERSIBLE WIND POWER TURBINE PLATFORM

(71) Applicant: BASSOE TECHNOLOGY AB, Göteborg (SE)

(72) Inventors: Robert Ludwigsson, Göteborg (SE); Yungang Liu, Partille (SE); Joakim Nilsson, Fjärås (SE); Jimmy Bondeson, Kållered (SE); Fredrik Arvidsson, Torslanda (SE)

(21) Appl. No.: 18/728,700

(22) PCT Filed: Jan. 11, 2023
(86) PCT No.: PCT/EP2023/050537

§ 371 Date: Jul. 12, 2024

(30) Foreign Application Priority Data
Jan. 14, 2022 (SE) 2250021-9
Jan. 14, 2022 (SE) 2250022-7
Jan. 14, 2022 (SE) 2250023-5
Jan. 14, 2022 (SE) 2250024-3
Jun. 20, 2022 (SE) 2250755-2
Aug. 26, 2022 (CN) 202211037940.9
Sep. 30, 2022 (SE) 2251139-8

(51) Int. Cl. B63B 35/44; B63B 1/10; B63B 39/06

(52) U.S. Cl. CPC B63B 35/44; B63B 1/107; B63B 2035/446; B63B 2039/067; B63B 2241/24

(57) ABSTRACT

A hull structure for a semi-submersible wind power turbine platform. The hull structure includes first, second and third buoyant stabilizing columns extending in a substantially vertical direction; and first and second elongated submersible buoyant pontoon structures extending in a substantially horizontal direction. The the hull structure generally has a V-shape in the horizontal plane with the first and second pontoon structures forming legs in the V-shape and with the second column located where the legs meet. The second column has a cross sectional area at its intended operational waterline that is larger than the cross sectional area of each of the first and third columns at their corresponding intended operational waterlines so that the second column exhibits an operational waterplane area that is larger than the operational waterplane area of each of the first and third columns when the hull structure is set in the operational state.

### TECHNICAL FIELD

This invention relates to a hull structure for a semi-submersible wind power turbine platform.

### BACKGROUND OF THE INVENTION

There is a growing interest for offshore wind power, i.e., sea-based wind power stations/turbines that produce electricity. Such a wind turbine may have a fixed underwater foundation or, in particular at water depths larger than around 50-60 m, may be arranged on a floating platform anchored to the bottom.

A floating wind power turbine platform may be of a semi-submersible type comprising a semi-submersible hull structure onto which a wind turbine tower is arranged. The hull structure is typically made up of a plurality of stabilizing buoyant columns connected by submersible buoyant pontoons or other connection members. The turbine tower is typically arranged onto one of the columns. An example of a semi-submersible wind power turbine platform is disclosed in WO2021/219787.

Platforms of this type are large constructions. For instance, each column of a 10 MW wind power turbine platform may have a height of 30 m and the distance between the columns may be 60-80 m. The total weight of the hull structure may be more than 3000 tons. The turbine tower may extend up to, say, 150 m above sea level and each turbine blade may be more than 100 m long.

A challenge in the field of offshore wind power is manufacturing, transportation and installation of the semi-submersible platforms. Towing of a platform with the wind turbine tower and blades etc. installed is complicated and challenging, and to reduce the towing distance for such a complete platform it is preferably arranged so that the turbine tower and the turbine blades etc. are installed onto the hull structure in a sheltered location relatively close to the final offshore location. A particular transportation challenge arises if the hull structure is manufactured at a construction yard located far away from the sheltered location, for instance because there is no construction yard suitable for such large and heavy hull structures available at or near the sheltered location. In such a situation the hull structures need to be transported a relatively long distance.

A further challenge with regard to semi-submersible wind power turbine platforms is to design the hull structure so that the platform becomes robust and stable also under harsh offshore conditions and so that the platform withstands many years of operation under such conditions.

A still further challenge is of course that manufacturing, transportation, installation, operation, etc. of the platform or hull structure must be cost efficient for keeping and increasing the interest for offshore wind power.

### SUMMARY OF THE INVENTION

An object of this invention is to provide a hull structure for a semi-submersible wind power turbine platform, where the hull structure exhibits improved properties with regard to reduced pitch moment and improved stability (reduced motions) when in operation.

A hull structure/platform of the type concerned in this disclosure will, when arranged at open sea, exhibit relatively complex heave and pitch movements as a result of waves, wind and currents. The invention is partly based on the realization that a conventional V-shaped semi-submersible hull structure essentially comprising three identical columns connected by two submersed pontoons typically has a longitudinal center of flotation (LCF) that is located at a significant distance (along a longitudinal axis that symmetrically separates the V-shape) from a point that may be denoted a longitudinal center of equivalent mass (LCEM) and that may be seen as the centroid of the maximum downwardly directed heave forces due to wave action, and as a result a heave-pitch induced moment will occur. The longitudinal position of the LCEM is a function of e.g., the total horizontally projected area of the two pontoons. In the absence of any particular elements that may affect the position of the LCEM, the LCEM will be located halfway between the column at the tip of the V and the two other columns of a conventional V-shaped semi-submersible hull structure as described above. On the other hand, the LCF of such a hull structure will be located ⅓ of the distance from the two columns at the open end of the V (as follows from the geometry laws for an isosceles or equilateral triangle). The distance along the longitudinal axis between the LCF and the LCEM in such a hull structure will thus be ½-⅓=⅙ or 16.7% of the distance between the tip column and the other two columns. Since the LCF forms a centroid of the upwardly directed heave forces, this significant distance between the LCF and the LCEM leads to a significant pitch moment of the conventional hull structure about a y-axis perpendicular to the longitudinal axis and located between the LCF and the LCEM. In turn, such a significant pitch moment has a significant negative effect on the pitch motions of the hull structure/platform.

The invention concerns a hull structure for a semi-submersible wind power turbine platform, wherein the hull structure comprises: first, second and third buoyant stabilizing columns extending in a substantially vertical direction; and first and second elongated submersible buoyant pontoon structures extending in a substantially horizontal direction.

The first pontoon structure extends between and connects the first and the second column, wherein the first pontoon structure is connected to a lower part of each of the first and second columns. Similarly, the second pontoon structure extends between and connects the second and the third column, wherein the second pontoon structure is connected to a lower part of each of the second and third columns.

The first and second pontoon structures are arranged in a V-shape in the horizontal plane with the first and second pontoon structures forming legs in the V-shape and with the second column located where the legs meet.

Each of the first, second and third columns has an intended operational waterline at least approximately corresponding to a water surface when the hull structure is set in an operational state with the first and second pontoon structures submerged beneath the water surface and with the first, second and third columns extending through the water surface.

The second column has a cross sectional area at its intended operational waterline that is larger than the cross sectional area of each of the first and third columns at their corresponding intended operational waterlines so that the second column exhibits an operational waterplane area that is larger than the operational waterplane area of each of the first and third columns when the hull structure is set in the operational state.

An effect of such a hull structure design is that the position of the LCF is moved along the longitudinal axis towards the second column, i.e., towards the tip of the V. This means also that the LCF is moved towards the LCEM so as to decrease the distance between these points. In turn, this reduces the pitch moment and reduces the pitch motions of the hull structure/platform compared to a conventional V-shaped semi-submersible hull structure as described above.

The operational waterplane area of the second column may be of a relative magnitude such that the distance between the LCF and the LCEM becomes, for instance, less than 10%, less than 5% or less than 3% of the distance between the tip column and the other two columns. With an even larger relative size of the operational waterplane area of the second column, the LCF and the LCEM may be located in substantially the same position along the longitudinal direction of the hull structure; it is even possible to locate the LCF closer to the second column than the LCEM, which may be beneficial depending on the circumstances.

Another way to reduce the distance between the LCF and the LCEM is to move the LCEM closer to the LCF, i.e., to move the LCEM further away from the second column, by providing the hull structure with motion damping water entrapment plates (“heave plates”) arranged at the first and second columns. This may be used in combination with using an enlarged second column operational waterplane area, or may be used also if the operational waterplane area of each of the first, second and third column is the same. In some embodiments it may be useful to provide a heave plate also at the second column to dampen secondary order movements. Heave plates are further described below.

Although not necessary, the hull structure has typically a symmetric design with first and third columns, and first and second pontoon structures, having the same dimensions.

That the platform, and the hull structure, is semi-submersible means that the platform/hull structure can be partly located beneath the water surface when in operation. The entire pontoon structures and parts of the columns are typically located beneath the surface. Anchoring/securing of the platform/hull structure to the bottom can be arranged in different ways, e.g., catenary mooring, taut-leg mooring or tendon mooring.

In an embodiment, the cross sectional area of the second column at the intended operational waterline thereof is at least 15% larger than the corresponding cross sectional area of at least one of the first and third columns.

In an embodiment, the cross sectional area of the second column at the intended operational waterline thereof is less than 110% larger than the corresponding cross sectional area of at least one of the first and third columns.

In practice it is likely that it is suitable if the cross sectional area of the second column at the intended operational waterline thereof is 25-40%, or 30-35%, larger than the corresponding cross sectional area of each of the first and third columns, in particular where the hull structure also is provided with properly arranged motion damping water entrapment plates (“heave plates”).

In an embodiment, the second column has a width or diameter at its intended operational waterline that is larger than the width or diameter of each of the first and third columns at their corresponding intended operational waterlines. For instance, if all columns have a circular cross section, the second column has a larger diameter. Some or all of the columns may, however, have e.g., a polygonal cross section. In such a case it may be more appropriate to relate to the width of the column(s).

In an embodiment, the hull structure is provided with motion damping water entrapment plates arranged beneath an operational waterline of the hull structure given by the operational waterlines of the first, second and third columns. Motion damping water entrapment plates are known as such and may be used to move the LCEM to a position that is more favorable for the hull structure. The water entrapment plate plates may be arranged at the columns at a level where a lower side of the plates align with a lower side of the pontoon structures.

The term “motion damping water entrapment plate” concerns a plate adapted to damp heave, pitch and/or roll motions of the hull structure. The shorter terms “water entrapment plate” and “heave plate” are sometimes used in this disclosure as substitutes for the longer term “motion damping water entrapment plate”.

In an embodiment, the water entrapment plates (or “heave plates”) have a height or thickness that is less than half of the height or thickness of the first and second pontoon structures.

In an embodiment, the heave plates comprise a first heave plate arranged at the first column and a third heave plate arranged at the third column. This moves the LCEM away from the second column and can be used to decrease the distance between the LCEM and the LCF along the longitudinal axis.

In an embodiment, the first heave plate is arranged on a side of the first column that faces away from the second column and/or away from the third column but not on a side of the first column that faces the third column, and wherein the third heave plate is arranged on a side of the third column that faces away from the second column and/or away from the first column but not on a side of the third column that faces the first column.

By arranging the first and third heave plates this way they do not interfere “inside” the V-shape when stowing a plurality of similar hull structures side by side with the second column of a first hull structure located between the pontoon structures of a second adjacent hull structure (i.e., with the V's partly inserted into each other, like>>>but further together) in the water or on a marine transportation vessel. Such stowage in the water may be required to save quay-space when storing multiple hull structures for a period of time and such a transportation may be necessary if the hull structures are manufactured far from the location at which they are supposed to operate (and far from the location at which a turbine tower is to be mounted to the hull structure) as described in WO2021/219787. The higher the number of hull structures that can be stowed onto the marine vessel, the lower the cost for the transportation.

In an embodiment, the heave plates comprise a second heave plate arranged at the second column. This may be useful for dampening second order heave movements. Since heave plates arranged at the second column will move the LCEM towards the second column and, in most cases, away from the LCF, it is in most cases suitable to increase the area of the first and third heave plates when arranging a heave plate also at the second column to keep or reduce the increase of the distance between the LCF and the LCEM.

In an embodiment, the second heave plate is arranged on an inside of second column between the first and second pontoon structures. Preferably, the second column is provided with a recess adapted to receive the second heave plate so as to allow close stowing of at least two hull structures side by side with the second column of a first hull structure located between the pontoon structures of an adjacent second hull structure. The second heave plate is suitably aligned with a lower side of the second column (and with the lower sides of the pontoon structures) so that the recess forms part of the lower side of the column. Thus, when a plurality of hull structures is to be stowed close to each other on the marine transportation vessel, this can still be done by placing the recess of the second column onto the second heave plate of another (adjacent) hull structure.

In an embodiment, the hull structure exhibits a longitudinal axis extending horizontally through a centroid of the second column and a point halfway between centroids of the first and third columns, wherein a longitudinal center of flotation (LCF) of the hull structure is a centroid of the operational waterplane areas of the first, second and third column, wherein a longitudinal center of equivalent mass (LCEM) of the hull structure is given by:

$$L C E M = ( {A}_{PS} \cdot {X}_{PS} + 0.5 \cdot {A}_{HP} \cdot {X}_{HP} ) / ( {A}_{PS} + 0.5 \cdot {A}_{HP} ) ,$$

where
A_{PS}=total horizontally projected area of the first and second pontoon structures,
X_{PS}=centroid of the A_{PS},
A_{HP}=total horizontally projected area of any motion damping heave plates arranged onto the hull structure, and
X_{HP}=centroid of the A_{HP},
wherein the hull structure is arranged such that a first distance (D1) between the LCF and the LCEM along the longitudinal axis of the hull structure is <10%, or <5% or <3%, of a second distance (D2) between the centroid of the second column and the point halfway between the centroids of the first and third columns.

The factor 0.5 is an approximate correction factor that takes into account that suitable heave plates typically has a height/thickness that is less than that of the pontoon structures (preferably less than half the height/thickness of the pontoon structures) and that the water flow pattern around and along the heave plates typically is different compared to around and along the pontoon structures. In the expression for LCEM, the area of the columns is not included in the total horizontally projected area of the first and second pontoon structures (A_{PS}).

It may be noted that if there are no heave plates it follows that A_{HP}=0, which reduces the LCEM-expression to LCEM=X_{PS}=the centroid of the total horizontally projected area of the first and second pontoon structures (A_{PS}), which is in the middle of the second distance (D2).

In an embodiment, the hull structure is arranged so as to exhibit: i) a first angle (α) in the horizontal plane between a central longitudinal axis of the first pontoon structure and a central longitudinal axis of the second pontoon structure; and ii) a second angle (β) in the horizontal plane between a) a first imaginary line between a central point of the first stabilizing column and a central point of the second stabilizing column and b) a second imaginary line between the central point of the second stabilizing column and a central point of the third stabilizing column.

The second angle (β) is 60° if the columns are arranged as the corners in a equilateral triangle. The central points of the columns mentioned above correspond to horizontal centroids of the columns.

In an embodiment, the second angle (β) is in the interval 55-90°, preferably 60-80°. A suitable interval in practice is likely to be 62-72° or 62-68°.

In an embodiment, the second angle (β) is larger than the first angle (α). This means that the pontoon structures, for instance, may be arranged centrally at the first and third columns (or somewhat towards an inside thereof, i.e., somewhat closer to the longitudinal axis of the hull structure) and be arranged at/connected to the second column somewhat towards an outside of the second column. This provides additional space between the pontoon structures at the second column, which facilitates close stowing of a plurality of similar hull structures on a marine transportation vessel, as also mentioned above. A first hull structure can be stowed closer to an adjacent second hull structure since, when the second angle (β) is larger than the first angle (α), there is more room for the first hull structure's second column between the pontoon structures of the second hull structure.

A further aspect of the invention concerns a hull structure for a semi-submersible wind power turbine platform, wherein the hull structure comprises: first, second and third buoyant stabilizing columns extending in a substantially vertical direction; and first and second elongated submersible buoyant pontoon structures extending in a substantially horizontal direction; wherein the first pontoon structure extends between and connects the first and the second column, wherein the first pontoon structure is connected to a lower part of each of the first and second columns; wherein the second pontoon structure extends between and connects the second and the third column, wherein the second pontoon structure is connected to a lower part of each of the second and third columns; wherein the first and second pontoon structures are arranged in a V-shape in the horizontal plane with the first and second pontoon structures forming legs in the V-shape and with the second column located where the legs meet; wherein each of the first, second and third columns has an intended operational waterline at least approximately corresponding to a water surface when the hull structure is set in an operational state with the first and second pontoon structures submerged beneath the water surface and with the first, second and third columns extending through the water surface, wherein each of the first, second and third column has a cross sectional area at its intended operational waterline defining an operational waterplane area of each of the columns when the hull structure is set in the operational state, wherein the hull structure exhibits a longitudinal axis extending horizontally through a centroid of the second column and a point halfway between centroids of the first and third columns, wherein a longitudinal center of flotation (LCF) of the hull structure is a centroid of the operational waterplane areas of the first, second and third column, wherein a longitudinal center of equivalent mass (LCEM) of the hull structure is given by:

$$L C E M = ( {A}_{PS} \cdot {X}_{PS} + 0.5 \cdot {A}_{HP} \cdot {X}_{HP} ) / ( {A}_{PS} + 0.5 \cdot {A}_{HP} ) ,$$

where
A_{PS}=total horizontally projected area of the first and second pontoon structures,
X_{PS}=centroid of the A_{PS},
A_{HP}=total horizontally projected area of any motion damping heave plates arranged onto the hull structure, and
X_{HP}=centroid of the A_{HP},
wherein the hull structure is arranged such that a first distance (D1) between the LCF and the LCEM along the longitudinal axis of the hull structure is <10%, or <5% or <3%, of a second distance (D2) between the centroid of the second column and the point halfway between the centroids of the first and third columns.

Thus, the specified relative maximum difference between the first and second distances is achieved by adjusting the operational waterplane areas of the columns and/or by providing the hull structure with properly arranged heave plates. What is said further above about the hull structure holds also for this further aspect of the invention.

A still further aspect of the invention concerns a hull structure for a semi-submersible wind power turbine platform, wherein the hull structure comprises: first, second and third buoyant stabilizing columns extending in a substantially vertical direction; and first and second elongated submersible buoyant pontoon structures extending in a substantially horizontal direction; wherein the first pontoon structure extends between and connects the first and the second column, wherein the first pontoon structure is connected to a lower part of each of the first and second columns; wherein the second pontoon structure extends between and connects the second and the third column, wherein the second pontoon structure is connected to a lower part of each of the second and third columns; wherein the first and second pontoon structures are arranged in a V-shape in the horizontal plane with the first and second pontoon structures forming legs in the V-shape and with the second column located where the legs meet; wherein each of the first, second and third columns has an intended operational waterline at least approximately corresponding to a water surface when the hull structure is set in an operational state with the first and second pontoon structures submerged beneath the water surface and with the first, second and third columns extending through the water surface, wherein the hull structure is provided with motion damping heave plates arranged beneath an operational waterline of the hull structure given by the operational waterlines of the first, second and third columns, wherein the heave plates comprise a first heave plate arranged at the first column and a third heave plate arranged at the third column, wherein the first heave plate is arranged on a side of the first column that faces away from the second column or away from the third column but not on a side of the first column that faces the third column, and wherein the third heave plate is arranged on a side of the third column that faces away from the second column or away from the first column but not on a side of the third column that faces the first column.

Thus, in this still further aspect of the invention, the hull structure is provided with heave plates configured to adjust the position of the LCEM so as to provide for a smaller pitch moment. Further, the heave plates are arranged so as to allow for close stowing of a plurality of similar hull structures on a marine transportation vessel as described above.

In an embodiment, the heave plates comprise a second heave plate arranged at the second column, and wherein the second heave plate is arranged on an inside of second column between the first and second pontoon structures.

In an embodiment, the heave plates have a height or thickness that is less than half of the height or thickness of the first and second pontoon structures.

In an embodiment, each of the first, second and third columns has a cross sectional area at its intended operational waterline defining an operational waterplane area of each of the columns when the hull structure is set in the operational state, wherein the hull structure exhibits a longitudinal axis extending horizontally through a centroid of the second column and a point halfway between centroids of the first and third columns, wherein a longitudinal center of flotation (LCF) of the hull structure is a centroid of the operational waterplane areas of the first, second and third column, wherein a longitudinal center of equivalent mass (LCEM) of the hull structure is given by:

$$L C E M = ( {A}_{PS} \cdot {X}_{PS} + 0.5 \cdot {A}_{HP} \cdot {X}_{HP} ) / ( {A}_{PS} + 0.5 \cdot {A}_{HP} ) ,$$

where
A_{PS}=total horizontally projected area of the first and second pontoon structures,
X_{PS}=centroid of the A_{PS},
A_{HP}=total horizontally projected area of the motion damping heave plates, and X_{HP}=centroid of the A_{HP},
wherein the hull structure is arranged such that a first distance (D1) between the LCF and the LCEM along the longitudinal axis of the hull structure is <10%, or <5% or <3%, of a second distance (D2) between the centroid of the second column and the point halfway between the centroids of the first and third columns.

General embodiments of the different hull structures above include:
each of the first and the second pontoon structures has, at least along a major part of its length, a width that is less than a width of the lower part of the second stabilizing column;
each of the first and second pontoon structures has an outer side facing away sideways from the hull structure and an inner side facing inwards towards the hull structure, wherein at least one of the first and second pontoon structures is arranged such that the outer side thereof is located closer to a corresponding outer side of the second stabilizing column than the inner side thereof is located in relation to a side of the second stabilizing column opposite the outer side of the second stabilizing column;
each of the first and second pontoon structures has a lower side facing downwards and wherein the lower sides of the first and second pontoon structures are substantially aligned with each other in the horizontal plane;
the lower sides of the first and second pontoon structures are substantially aligned with downwardly facing lower sides of each of the first, second and third buoyant stabilizing columns;
the first and second pontoon structures have a substantially equal length;
the hull structure includes no further columns or pontoon structures in addition to the columns and pontoon structures specified.

What is said in this disclosure regarding larger operational waterplane area for the second column, LCF, LCEM, pitch moment, water entrapment plates, etc. for a V-shaped hull structure holds in principle also for a hull structure provided with an additional (a third) elongated submersible connection structure provided between the first and third columns and/or between the first and second pontoon structures so as to connect the legs of the V and provide the hull structure with a general shape that may be denoted Δ-shape or A-shape. Such a third elongated submersible connection structure may be a buoyant pontoon structure similar to the first and second pontoon structures or may be a non-buoyant structure.

Thus, in an embodiment the hull structure comprises a third elongated submersible connection structure extending in a substantially horizontal direction between the lower part of the first column and the lower part of the third column and/or between the first and second pontoon structures so as to form a Δ- or A-shape in the horizontal plane together with the first and second pontoon structures.

Also Δ- and A-shaped hull structures may in principle be partly inserted into each other and provide for close positioning and efficient stowing. In an embodiment, the third connection structure has a height that is less than that of each of the first and second pontoon structures, wherein the third connection structure is arranged so that an upper side thereof is located at a lower level than an upper side of each of the first and second pontoon structures. This makes it easier to stow two hull structures close together onto a flat surface, such as a cargo deck of a marine vessel, since the first and second pontoon structures of a first hull structure inserted into another hull structure will be located onto the third connection structure of that second hull structure, and the lower the third connection structure, the less inclined position will the first hull structure need to occupy. The height of the third connection structure is preferably less than 50% of the height of the first and second pontoon structures.

In an embodiment, the hull structure as a whole is arranged to exhibit a V-shape or a Δ-shape or an A-shape in the horizontal plane where the first and second pontoon structures form the V-shape or two sides in the Δ- or A-shape. The terms V-, Δ- and A-shape refer to the general shape set by the two or three pontoon/connection structures mentioned above.

In an embodiment, the hull structure has no additional column besides the first, second and third columns.

### BRIEF DESCRIPTION OF DRAWINGS

In the description of the invention given below reference is made to the following figure, in which:

FIG. 1 shows a prior art hull structure in a sectional view taken along an intended waterline.

FIG. 2 shows a perspective view of the prior art hull structure of FIG. 1.

FIG. 3 shows a first embodiment of a hull structure according to this disclosure in a sectional view taken along an intended waterline.

FIG. 4 shows a perspective view of the embodiment of FIG. 3.

FIG. 5 shows a second embodiment of a hull structure according to this disclosure in a sectional view taken along an intended waterline.

FIG. 6 shows a perspective view of the embodiment of FIG. 5.

FIG. 7 shows a third embodiment of a hull structure according to this disclosure in a sectional view taken along an intended waterline.

FIG. 8 shows a perspective view of the embodiment of FIG. 7.

FIG. 9 shows a side view of the embodiment of FIG. 7.

FIG. 10 shows schematically a plurality of hull structures according to FIG. 7 closely stowed onto a deck of a marine transportation vessel.

FIG. 11 (FIGS. 11A and 11B) shows perspective views of a plurality of hull structures according to FIG. 7 closely stowed onto a deck of a marine transportation vessel.

FIG. 12 shows principles behind a pitch moment of a V-shaped hull structure.

FIG. 13 shows a semi-submersible wind power turbine platform comprising a hull structure according to FIG. 7.

### DESCRIPTION OF EXAMPLE EMBODIMENTS OF THE INVENTION

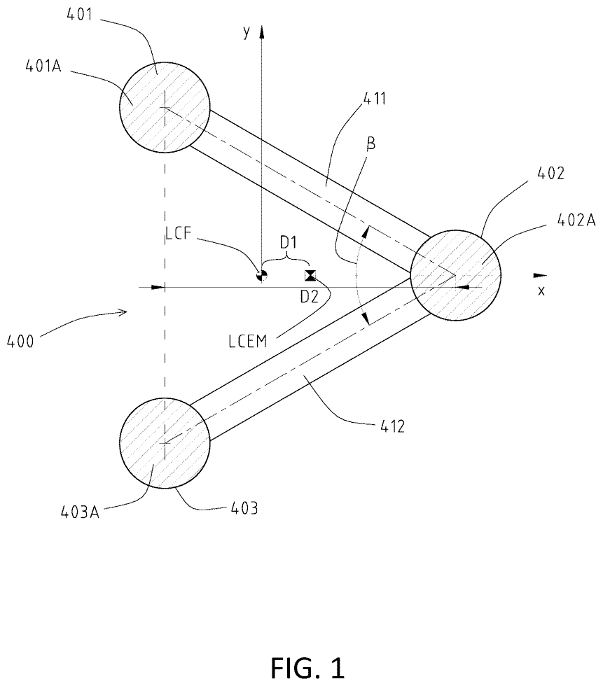

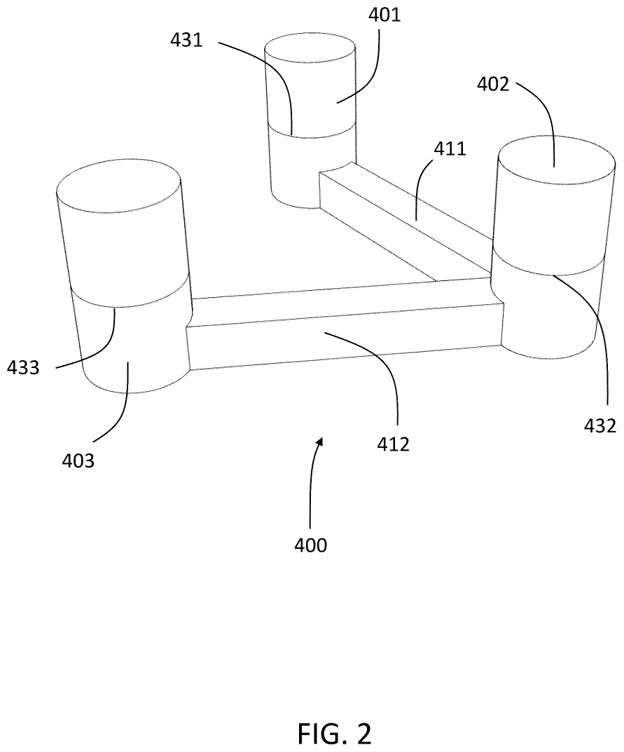

FIGS. 1-2 show a prior art V-shaped hull structure 400 comprising first, second and third columns 401, 402, 403, a first pontoon 411 connecting the first and second columns and a second pontoon 412 connecting the second and third columns. All columns have the same shape and dimensions and exhibit the same cross sectional area 401A, 402A, 403A at a corresponding intended operational waterline 431, 432, 433 so as to exhibit the same waterplane area when set in an operational state with the pontoons 411, 412 and parts of the columns located beneath a water surface. The columns are positioned as the corners of an equilateral triangle and the pontoons extend along an imaginary line between center points (centroids) of connected columns. An angle β between the pontoons (and between the imaginary lines between the column center points) is thus 60°.

The hull structure 400 exhibits a longitudinal axis (x-axis) extending horizontally through a centroid of the second column 402 and a point halfway between centroids of the first and third columns 401, 403. A longitudinal center of flotation (LCF) of the hull structure 400 is a centroid of the operational waterplane areas of the first, second and third columns. A longitudinal center of equivalent mass (LCEM) of the hull structure is given by: LCEM=X_{PS}=a centroid of the total horizontally projected area of the first and second pontoon structures (A_{PS}). A distance between the LCF and the LCEM along the longitudinal axis of the hull structure is denoted a first distance D1. A distance between the centroid of the second column 402 and the point halfway between the centroids of the first and third columns 401, 403 is denoted a second distance D2.

Since the hull structure 400 resembles an equilateral triangle, the position of the LCF is ⅓ of the second distance D2 from the point halfway between the centroids of the first and third columns 401, 403 (see FIG. 1). Since the hull structure 400 is symmetric with identical pontoons 411, 412, the position of the LCEM is in the middle of the second distance D2 (see FIG. 1). The first distance D1 then becomes ⅙ of the second distance D2, i.e., 16.7% of D2.

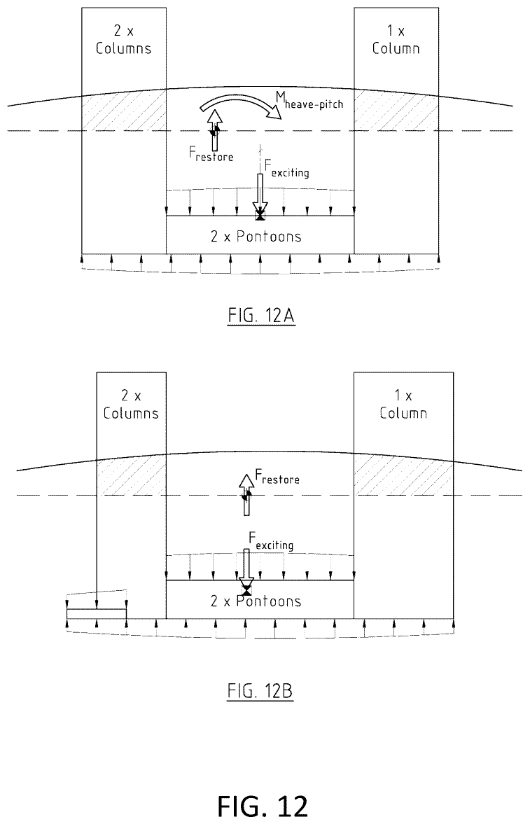

As described further above and also below in relation to FIG. 12, the distance D1 between the LCF and the LCEM results in that a heave-pitch induced moment will occur. The shorter the distance D1 (for a given D2), the smaller the pitch moment and the higher the stability of the hull structure/platform.

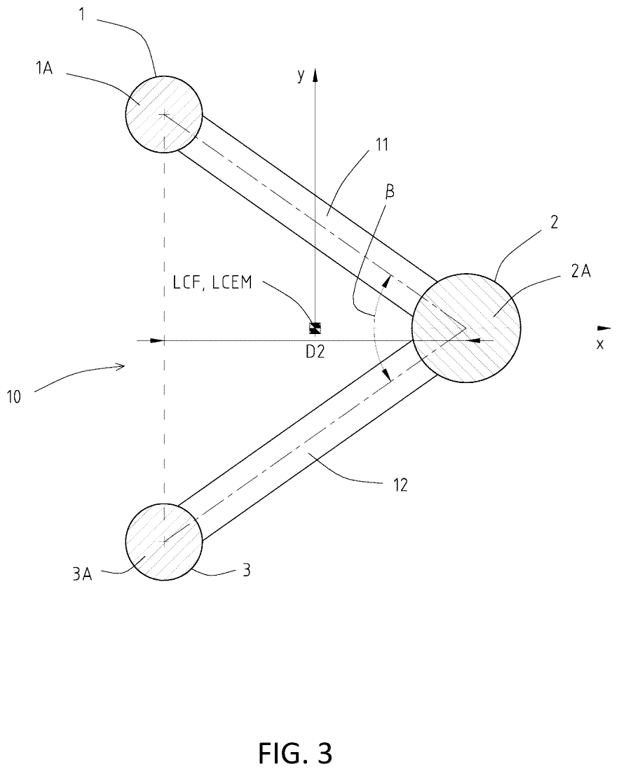

FIGS. 3-13 show various embodiments of inventive hull structures which all exhibit a smaller relative ratio between the first and second distances D1 and D2, and the hull structures of FIGS. 3-13 thus exhibit a smaller pitch moment than the prior art hull structure 400 shown in FIGS. 1-2. In FIGS. 3-13 the same reference numbers have been used for similar parts of the hull structures.

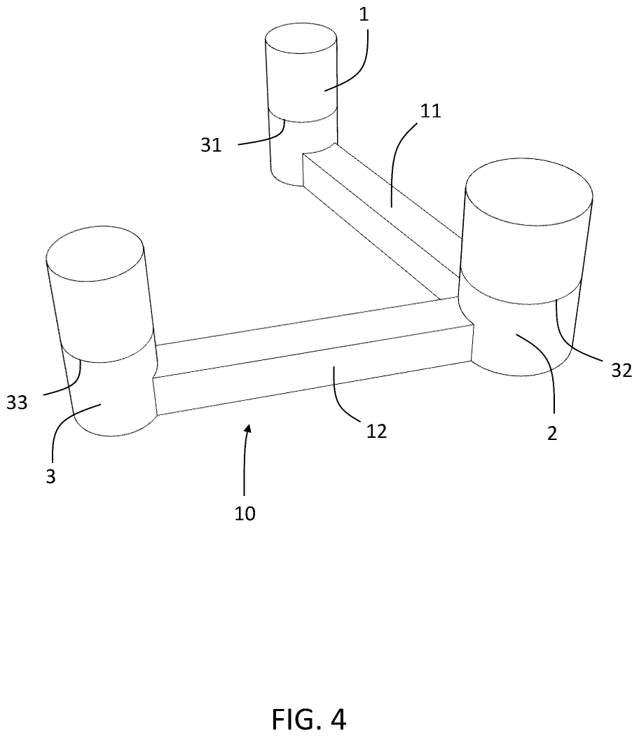

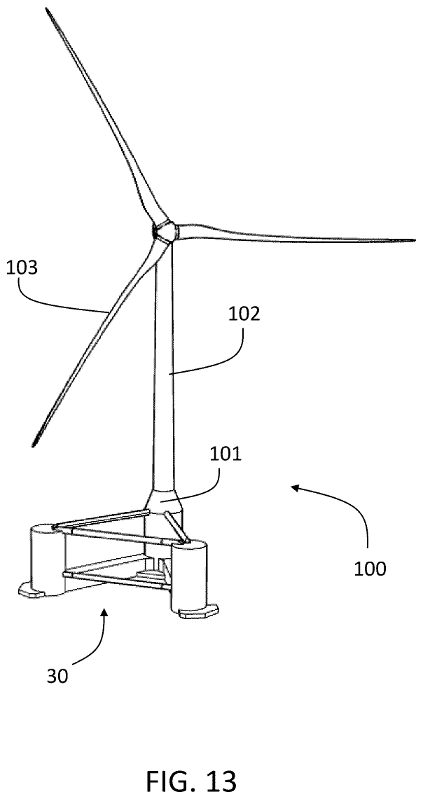

FIGS. 3-4 show a first embodiment of a hull structure 10 for a semi-submersible wind power turbine platform 100 (see FIG. 13). The hull structure 10 comprises: first, second and third buoyant stabilizing columns 1, 2, 3 extending in a substantially vertical direction; and first and second elongated submersible buoyant pontoon structures 11, 12 extending in a substantially horizontal direction. The hull structure 10 exhibits in general a V-shape in the horizontal plane with the first and second pontoon structures 11, 12 forming legs in the V-shape and with the second column 2 located where the legs meet. The first pontoon structure 11 extends between and connects the first and the second column 1, 2, and the first pontoon structure 11 is connected to a lower part of each of the first and second columns 1, 2 (see FIG. 4). Similarly, the second pontoon structure 12 extends between and connects the second and the third column 2, 3, wherein the second pontoon structure 12 is connected to a lower part of each of the second and third columns 2, 3.

As shown in FIG. 4, each of the first, second and third columns 1, 2, 3 has an intended operational waterline 31, 32, 33 at least approximately corresponding to a water surface when the hull structure 10 is set in an operational state with the first and second pontoon structures 11, 12 submerged beneath the water surface and with the first, second and third columns 1, 2, 3 extending through the water surface.

As shown in FIG. 3, the second column 2 has a cross sectional area 2A at its intended operational waterline 32 that is larger, in this example 100% larger, than the cross sectional area 1A, 3A of each of the first and third columns 1, 3 at their corresponding intended operational waterlines 31, 33 so that the second column 2 exhibits an operational waterplane area that is larger, in this example 100% larger, than the operational waterplane area of each of the first and third columns 1, 3 when the hull structure 10 is set in the operational state.

In similarity with what is described above regarding the prior art hull structure 400 shown in FIGS. 1-2, also the hull structure 10 of FIGS. 3-4 exhibits a longitudinal axis (x-axis) extending horizontally through a centroid of the second column 2 and a point halfway between centroids of the first and third columns 1, 3. The LCF and LCEM for the hull structure 10 of FIGS. 3-4 are obtained in the similar way as for the prior art hull structure 400 described above. In contrast to FIGS. 1-2, the cross sectional area 2A and thus the waterplane area of the second column 2 of the hull structure 10 of FIGS. 3-4 is 100% larger than (i.e., twice as large as) each of that of the first and third columns 1, 3. This means that the LCF for the hull structure 10 becomes located in the middle of the second distance D2 (where the second distance D2 is the distance from the point halfway between the centroids of the first and third columns 1, 3). Since the LCEM of the hull structure is not affected by the change in waterplane area of the columns, the position of the LCEM is still in the middle of the second distance D2, i.e., at the same position as the LCF (see FIG. 3). The first distance D1, i.e., the distance between LCF and LCEM along the longitudinal x-axis, then becomes (close to) zero. The hull structure 10 does therefore not induce any pitch moment about a horizontal y-axis perpendicular to the x-axis.

It is suitable to have an at least roughly equal stability in both x- and y-directions and therefore is the angle β of the hull structure 10 in FIGS. 3-4 larger than 60° (around70°).

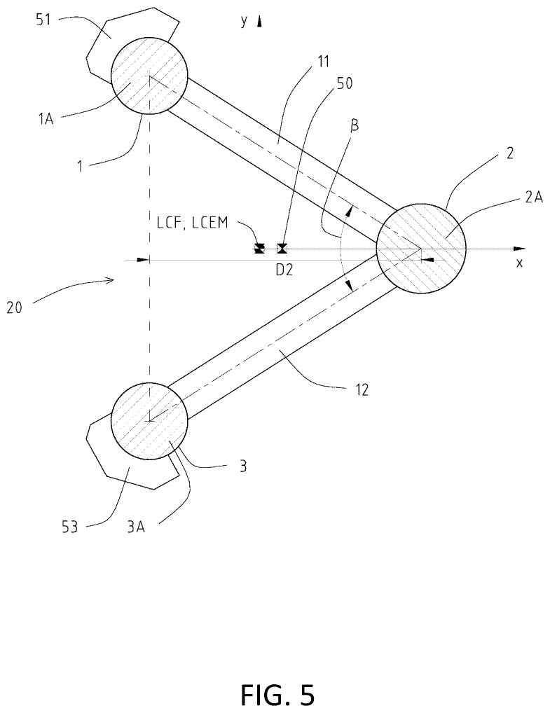

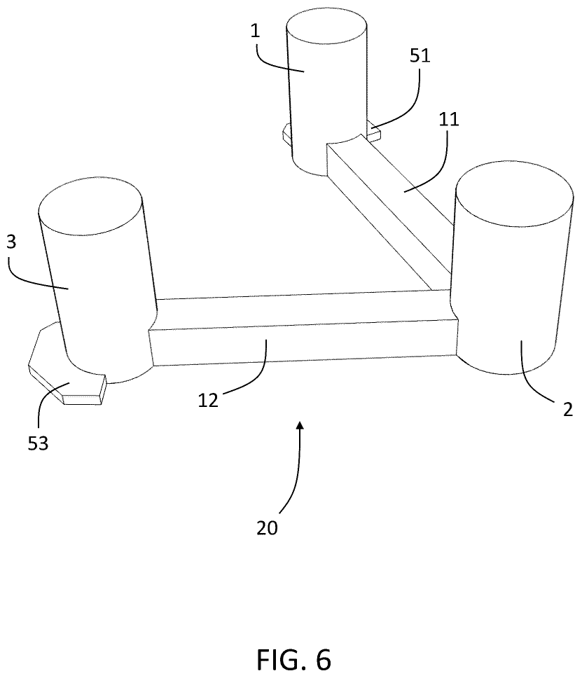

FIGS. 5-6 show a second embodiment of a hull structure 20 for a semi-submersible wind power turbine platform 100 (see FIG. 13). A difference between the first embodiment shown in FIGS. 3-4 and the second embodiment shown in FIGS. 5-6 is that the cross sectional area 2A of the second column 2 in FIGS. 5-6 is now around 50% (instead of 100%) larger than the cross sectional area 1A, 3A of each of the first and third columns 1, 3. A further difference is that the hull structure 20 is provided with motion damping water entrapment plates 51, 53. A still further difference is that the angle β in FIG. 5 is somewhat smaller than in FIG. 3 (around 65° in FIG. 5).

Because the waterplane area of the second column 2 of the hull structure 20 is only 50% larger than that of each of the waterplane areas of the first and second column 1, 3, the LCF is not moved all the way to a nominal LCEM (indicated by reference number 50) as was the case for the hull structure 10 of FIGS. 3-4. To reduce the distance D1 between the LCF and the actual LCEM, a first water entrapment plate 51 is arranged at the first column 1 and a further or third water entrapment plate 53 is arranged at the third column 3. These plates 51, 53 moves the LCEM away from the second column 2 (to the left in FIG. 5) from the nominal LCEM 50 (without plates 51, 53) and towards the LCF so that the distance D1 between the LCF and LCEM becomes (close to) zero (see FIG. 5).

The first and further/third motion damping water entrapment plates 51, 53 are arranged beneath an operational waterline of the hull structure 20 given by the operational waterlines of the first, second and third columns 1, 2, 3. The plates 51, 53 have a height or thickness that is less than half of the height or thickness of the first and second pontoon structures 11, 12 (see FIG. 6).

The first and further/third motion damping water entrapment plates 51, 53 are further arranged so that the first plate 51 is arranged on a side of the first column 1 that faces away from the second column 2 and on a side that faces away from the third column 3, but not on a side of the first column 1 that faces the third column 3. Similarly, the further or third plate 53 is arranged on a side of the third column 3 that faces away from the second column 2 and on a side that faces away from the first column 1, but not on a side of the third column 3 that faces the first column 1. As will be further described below, this allows two or more hull structures 20 to be stowed closely together for transport.

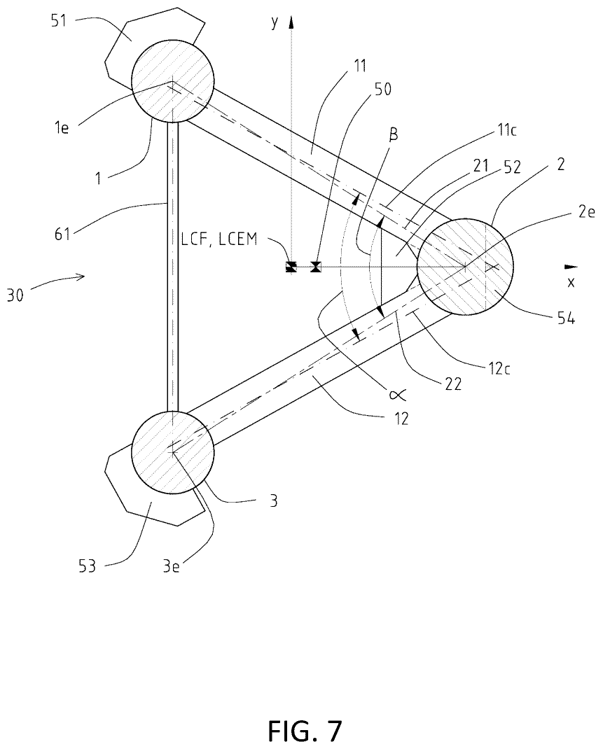

FIGS. 7-9 show a third embodiment of a hull structure 30 for a semi-submersible wind power turbine platform 100 (see FIG. 13). A difference compared to the embodiment of FIGS. 5-6 is that the hull structure 30 is provided with a still further (or second) water entrapment plate 52 arranged at the second column 2 at an inside thereof between the first and second pontoon structures 11, 12. Arranging a water entrapment plate at the second column 2 is useful for damping certain second order movements. Positioning the second plate 52 inside facilitates close stowing of hull structures, as described further below.

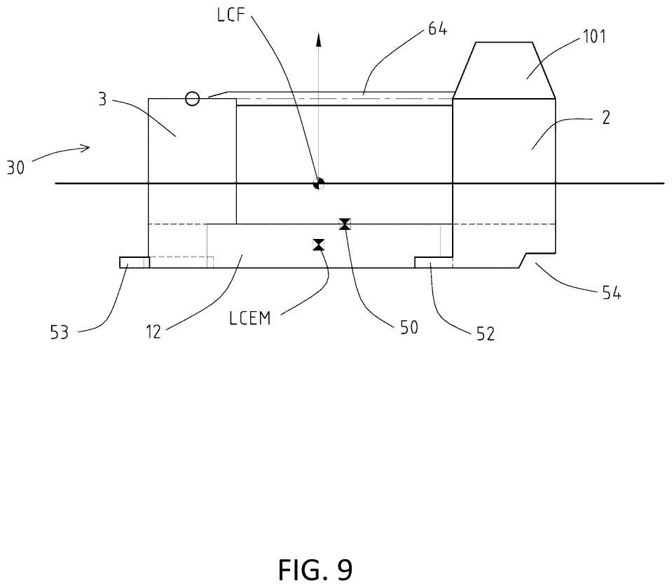

If no other actions are taken, the still further or second plate 52 would typically move the LCEM towards the second column 2 and thus normally away from the LCF so as to increase the distance D1 between the LCF and the LCEM. To compensate for this and reduce or eliminate this, the size of the first and further/third plates 51, 53 can be increased. Reference number 50 in FIGS. 7 and 9 indicate the nominal position of the LCEM without any water entrapment plates 51-53.

A further difference compared to the embodiment of FIGS. 5-6 is that the second column 2 of the hull structure 30 is provided with a recess 54 adapted to receive the second water entrapment plate 52 so as to allow close stowing of at least two hull structures 30 side by side with the second column of a first hull structure located between the pontoon structures of an adjacent second hull structure.

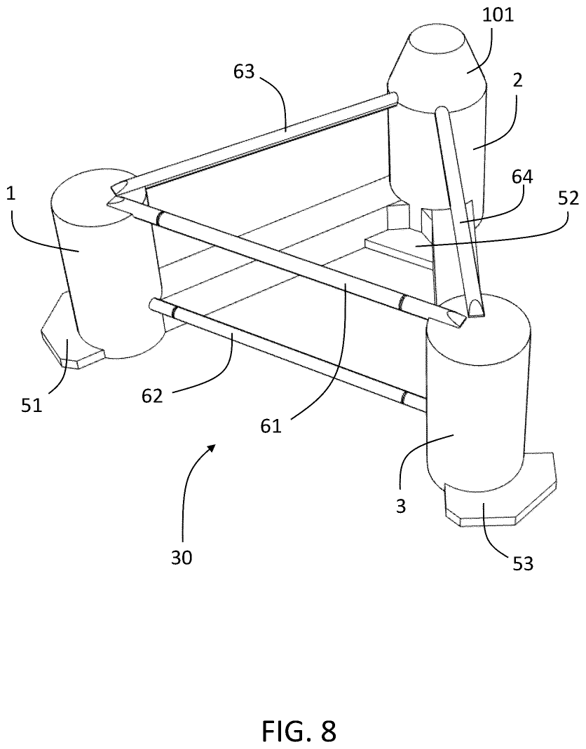

The hull structure 30 of FIGS. 7-9 is further provided with braces 61-64 that connect the columns and strengthens the hull structure 30. As indicated in FIG. 8. The braces 61, 62 that connect the first and third columns 1, 3 are separated into parts so that only end parts of these braces are fixed to the columns when manufacturing the hull structure 30, so as to allow stowing and transport, and so that mid parts can relatively easily be fixed to the end parts after transport.

As shown in FIG. 7, the hull structure 30 is arranged so as to exhibit:
i) a first angle (α) in the horizontal plane between a central longitudinal axis 11c of the first pontoon structure 11 and a central longitudinal axis 12c of the second pontoon structure 12; and
ii) a second angle (β) in the horizontal plane between a) a first imaginary line 21 between a central point (centroid) 1e of the first stabilizing column 1 and a central point (centroid) 2e of the second stabilizing column 2 and b) a second imaginary line 22 between the central point (centroid) 2e of the second stabilizing column 2 and a central point (centroid) 3e of the third stabilizing column 3.

The second angle β corresponds to the angle β mentioned in relation to FIGS. 1-6. In the hull structures of FIGS. 1-6, the angles α and β are equal.

The third embodiment of the hull structure 30 shown in FIGS. 7-9 exhibits a second angle β that is larger than the first angle α. As shown in FIG. 7, each pontoon structure 11, 12 extends in a direction that is non-parallel to the corresponding imaginary line 21, 22 towards an outer side of the second column 2. This gives more space between the pontoons at the inside the second column, which facilitates close stowing of hull structures.

As shown in FIGS. 8-9, the hull structure is further provided with a wind turbine tower support 101.

In all embodiments, the hull structure 10, 20, 30 exhibits a longitudinal axis (x-axis) extending horizontally through the centroid 2e of the second column 2 and a point halfway between centroids 1e, 3e of the first and third columns 1, 3. Further, the longitudinal center of flotation (LCF) of the hull structure 10, 20, 30 is a centroid of the operational waterplane areas of the first, second and third column 1, 2, 3. Further, the longitudinal center of equivalent mass (LCEM) of the hull structure is given by:

$$L C E M = ( {A}_{PS} \cdot {X}_{PS} + 0.5 \cdot {A}_{HP} \cdot {X}_{HP} ) / ( {A}_{PS} + 0.5 \cdot {A}_{HP} ) ,$$

where
A_{PS}=total horizontally projected area of the first and second pontoon structures 11, 12,
X_{PS}=centroid of the A_{PS},
A_{HP}=total horizontally projected area of the motion damping water entrapment plates 51, 52, 53 (if the hull structure is provided with any such plates), and
X_{HP}=centroid of the A_{HP}.

The hull structure 10, 20, 30 may then be arranged such that the first distance D1 between the LCF and the LCEM along the longitudinal axis of the hull structure is <10%, or <5% or <3%, of the second distance D2 between the centroid 2e of the second column 2 and the point halfway between the centroids 1e, 3e of the first and third columns 1, 3. It is thus not necessary that the distance D1 is close to zero as exemplified above.

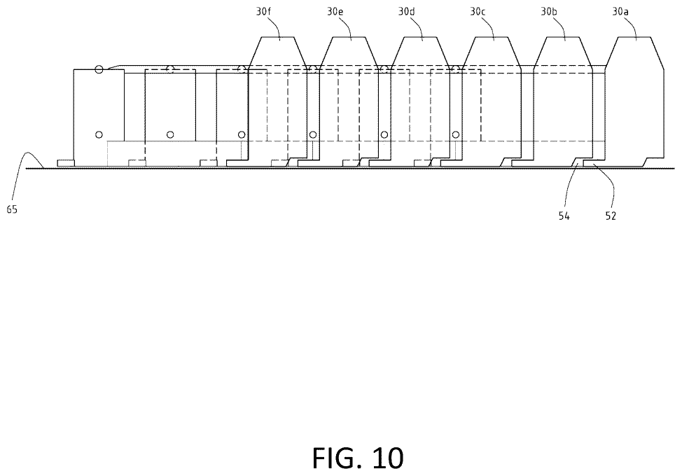

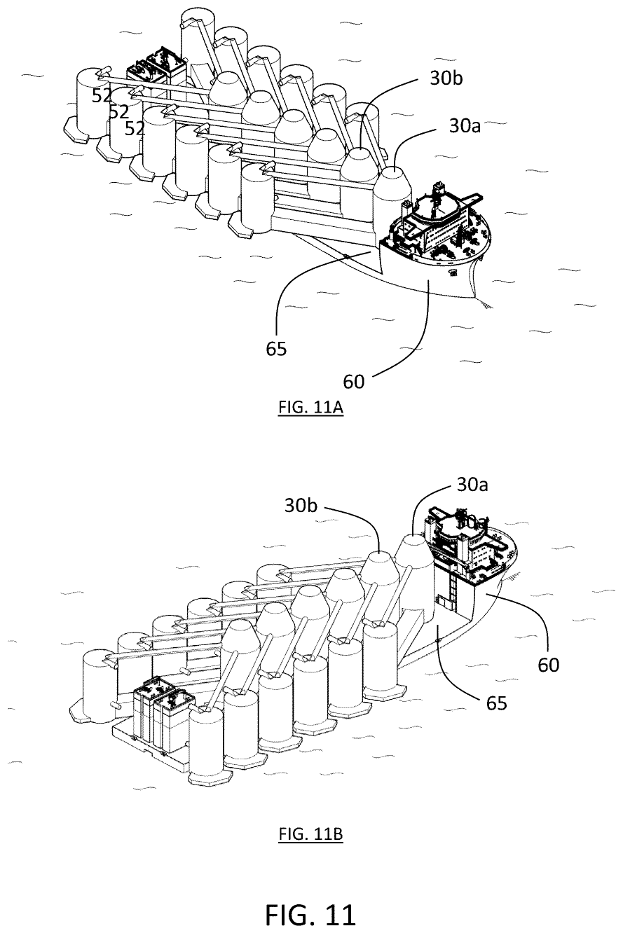

FIGS. 10-11 show, schematically in FIG. 10 and perspective views in FIGS. 11A and 11B, a set of hull structures 30a-30f according to FIGS. 7-9 closely stowed onto a deck 65 of a marine transportation vessel 60. The marine transportation vessel 60 is in the form of a semi-submersible cargo carrying marine vessel configured to be lowered partly below the water surface into a lower position and be raised to an upper position so as to load onto the vessel cargo that is located at the water surface above the vessel.

A method for loading the set of hull structures 30a-30f onto the semi-submersible cargo carrying marine vessel 60 may comprise:
providing the set of hull structures 30a-30f floating in water;
arranging the set of hull structures 30a-30f in a row above the marine vessel 60 when the marine vessel is in its lower position; and
raising the marine vessel 60 to its upper position so as to load the row of hull

FIG. 12 shows principles behind a pitch moment of a V-shaped hull structure. FIG. 12A shows schematic side view of a prior art hull structure similar to the hull structure 400 shown in FIGS. 1-2. FIG. 12B shows schematic side view of a hull structure according to this disclosure.

For a floating wind power turbine platform, reduced pitch and roll motions are in most cases more important than the heave motions. The background for this is that the turbine is located on a tower high above the platform and small pitch and roll motions will give large horizontal motions on the turbine, and accordingly will limit pitch and roll accelerations give high horizontal accelerations on the wind power turbine, resulting in large mass forces that translate into bending moments on the wind turbine supporting tower as well as into the platform structure.

For an asymmetric floating object, such as a floating wind turbine platform with a V-shaped pontoon, the asymmetry will result in additional heave-pitch coupling (and possible heave-roll coupling, but in the following the pitch is primarily discussed as this is the primary subject of interest for a V-shaped semi-submersible), which means that a heave motion will also introduce an additional pitch motion. Below follows a simplified description of the background for heave-pitch coupling and how this may be reduced.

In FIG. 12 is the situation with the maximum downward exciting wave force situation shown, i.e., when the wave-crest is above the center of the pontoons. The heave equation of motion may be written:

$$( M + {A}_{33} ) * {S}_{3}^{″} + {B}_{33} * {S}_{3}^{′} + {C}_{33} * {S}_{3} = {F}_{3} ( t )$$

where:
M is the mass/displacement
A₃₃ is the added mass in heave direction (i.e., weight of water moving together with the platform)
S″₃ is the acceleration in vertical (heave) direction (m/s2)
B₃₃ is the damping coefficient
S′₃ is the velocity in vertical direction (m/s)
C₃₃ is the vertical restoring coefficient
S₃ is the motion (distance) in vertical direction (m)
F₃(t) is the time dependent wave excitation force

A₃₃, B₃₃ and F₃ is wave frequency dependent and for wave-frequencies outside of the natural frequency in heave, B₃₃ has relatively limited influence on the heave motions and is therefore disregarded in the following discussion.

The added mass, A₃₃, is primarily acting on horizontal projected areas and as a result the vertical added mass force has a center of action roughly corresponding to the centroid of the project horizontal areas of the pontoons excluding the area covered by the columns (there is some added mass underneath the pontoons below the columns but this is lower and of less significance when water is both above and below a pontoon).

In the situation when the wave is pressuring the floating unit downwards, the additional buoyancy at the waterplane of the submerged column part will try to restore the unit to its initial position, i.e., an upwards restoring force will act in the centroid of the waterplane. The centroid of the water plane is in the marine industry known as the longitudinal center of floatation (LCF).

The vertical excitation force is a result of the wave-pressure acting on the pontoon. The wave-pressure on a location on the pontoon deck/bottom is a result of the height of the wave crest and the vertical position below the water, where it can be shown that:

$${F}_{3} ( t ) ∝ S {A}_{P} \times p where p ∝ H * {e}^{k * z}$$

where
Ap is the actual area of the pontoon (deck and bottom)
p is the wave pressure
H is the wave amplitude
k is the wave-number, which depends on the wave-length
Z is the vertical distance (depth) to the point of interest.

From the above it can be concluded that the (dynamic) pressure is decreasing exponentially with increased depth, i.e., the dynamic pressure is lower at the pontoon bottom than on the pontoon deck, i.e., a downwards excitation force will act on the pontoon when the wave crest is above the center of the pontoon (the exponential relationship is valid for deep waters, for shallow waters the relationship is more complex).

This excitation force creates a downwards acceleration/motion, which results in mass loads (due to weight and added mass) as well as an upwards restoring force due to the additional buoyancy of the columns, see also above (scientifically, this buoyancy/restoring force is a result of the increased pressure on the pontoon-bottom below the columns, as there is no pontoon deck below the columns which the downwards pressure act on).

The downwards force will therefore be the difference between the downwards pressure on the pontoon deck and the upwards force on the pontoon bottom, excluding the areas below the columns. This force will have a center of action roughly corresponding to the centroid of the projected horizontal areas of the pontoons with columns interface areas deduced.

From the above, it can be seen that both the added mass force and the wave excitation force in vertical direction is acting roughly in the centroid of the horizontally projected areas of the pontoon deck, while the restoring force, as described above, is acting at the centroid of the waterplane (LCF, see above).

When the centroid of the horizontal projected areas of the pontoon deck and the LCF is in different longitudinal positions, which is the case for a semi-submersible with three identical columns and a V-shaped pontoon, this will result in a heave induced pitch moment that will increase the pitch motion/acceleration.

For a semi-submersible with three identical columns in an equilateral triangle, the LCF is located ⅔=66.7% of the longitudinal column distance from the centroid of the column at the tip of the “V”. The horizontally projected area of the pontoon deck is on the other hand located at half-length=50%. Accordingly, for such a platform the distance between the excitation/added mass force and the restoring force is 16.7% of the longitudinal column distance, resulting in a large induced pitch moment. On the other hand, for a rotational symmetric three column platform with three pontoons (triangular or Delta pontoon configuration), the distance between the excitation force and the restoring force is 0.

To reduce this heave induced pitch moment, the horizontal distance between LCF and the centroid of the horizontal projected areas shall be reduced, preferably to 0 (zero). This can be achieved by moving both LCF and the centroid of the horizontal projected areas.

To move LCF towards the tip of the “V”, the waterplane area of the column at the tip shall be increased while the waterplane area of the columns at the outer end of the “V” shall be reduced. To keep the same stability in transverse direction, the horizontal distance between the outer columns needs to be increased when their waterplane area is decreased (i.e., increased angle β of “V”).

To move the centroid of the horizontally projected area of the pontoon deck away from the tip of the “V”, one possibility would be to extend the pontoons outside of the outer columns. However, this is negative as these pontoon extensions will obtain a large excitation force and moment arm when the wave crest is above the pontoon extensions.

A preferable alternative is instead to arrange water entrapment plates close to the pontoon bottom. Such water entrapment plates, which may be of buoyant double skin construction or single skin construction, will be due to their limited thickness have less excitation pressure due to their lower location (compared with the upper side of the pontoons) and less pressure difference between their upper side and lower side, but at the same time a horizontal plate provide an added mass (i.e., increase A₃₃).

While vertical water flow (creating added mass) of the pontoon primarily is two dimensional perpendicular to the center axis of the pontoon (limited flow along the pontoon which is further blocked by the columns at the end of the pontoons), the vertical flow around a water entrapment plate will be more three-dimensions, i.e., the water will be able to flow “around” the plate in different directions. Therefore the “effectiveness” of an area of water entrapment plate is reduced compared with the “effectiveness” of an area of the horizontally projected pontoon areas, and accordingly the water entrapments plate's ability to move the centroid of the mass/exciting force is also reduced.

The location of the average centroid of the combined pontoon deck and water entrapment plates added mass and excitation force is in the following denoted LCEM, Longitudinal Centre of Equivalent Mass. An approximate formula for estimation of LCEM can be written:

$$L C E M = ( {A}_{PS} \cdot {X}_{PS} + 0.5 \cdot {A}_{HP} \cdot {X}_{HP} ) / ( {A}_{PS} + 0.5 \cdot {A}_{HP} ) ,$$

where
A_{PS}=total horizontally projected area of the first and second pontoon structures,
X_{PS}=centroid of the A_{PS},
A_{HP}=total horizontally projected area of any motion damping heave plates arranged onto the hull structure, and

X_{HP}=centroid of the A_{HP},
and where the factor 0.5 is an “efficiency/weighting factor” empirically determined based on advanced hydrodynamic simulations.

While the hydrodynamical behavior of a floating structure is very complex, where added mass, dampening and excitation force is wave frequency, wave amplitude and time dependent with a wave-behavior that is non-linear as well as effected by the geometry of the floating structure, the method to calculate LCF and LCEM and arrange these at the same horizontal position, has proven to be a simplified and workable method to reduce the pitch motions of a floating wind turbine platform, and related horizontal accelerations on the wind turbine, due to the reduction in heave induced pitch moment.

FIG. 13 shows a semi-submersible wind power turbine platform 100 comprising a hull structure 30 according to FIG. 7. The platform 100 is provided with a wind turbine tower 102 in turn provided with three blades 103 (as well as a generator etc., which is not shown in the figures).

The invention is not limited by the embodiments described above but can be modified in various ways within the scope of the claims. For instance, the cross section of the columns and pontoon structures may be different than exemplified, such as polygonal columns and circular or polygonal pontoon structures.

One or more of the bracings/brace members 61-64 may be a stiff structure typically capable of carrying a load in both longitudinal directions, i.e., it can withstand both tensile and compression forces directed along its longitudinal axis. Alternatively, one or more of the brace members may be a wire, rope or other non-stiff structure, which may be pre-tensioned when installed, typically capable of carrying a load mainly, but not exclusively, when subject to longitudinally directed tensile forces. A stiff brace member may be made of a metallic material, such as steel, and may form a pipe or beam. A non-stiff brace member may be in the form of a wire or a rope and may be pre-tensioned so as to reduce the forces acting onto different parts of the hull structure during transport.

1. A hull structure for a semi-submersible wind power turbine platform (100), the hull structure comprising:
first, second and third buoyant stabilizing columns extending in a substantially vertical direction; and
first and second elongated submersible buoyant pontoon structures extending in a substantially horizontal direction;
wherein the first pontoon structure extends between and connects the first and the second column, wherein the first pontoon structure is connected to a lower part of each of the first and second columns;
wherein the second pontoon structure extends between and connects the second and the third column, wherein the second pontoon structure is connected to a lower part of each of the second and third columns;
wherein the first and second pontoon structures are arranged in a V-shape in the horizontal plane with the first and second pontoon structures forming legs in the V-shape and with the second column located where the legs meet;
wherein each of the first, second and third columns has an intended operational waterline at least approximately corresponding to a water surface when the hull structure is set in an operational state with the first and second pontoon structures submerged beneath the water surface and with the first, second and third columns extending through the water surface, and
wherein the second column has a cross sectional area at its intended operational waterline that is larger than the cross sectional area of each of the first and third columns at their corresponding intended operational waterlines so that the second column exhibits an operational waterplane area that is larger than the operational waterplane area of each of the first and third columns when the hull structure is set in the operational state.

2. The hull structure according to claim 1, wherein the cross sectional area of the second column at the intended operational waterline thereof is at least 15% larger than the corresponding cross sectional area of at least one of the first and third columns.

3. The hull structure according to claim 1, wherein the cross sectional area of the second column at the intended operational waterline thereof is less than 110% larger than the corresponding cross sectional area of at least one of the first and third columns.

4. The hull structure according to claim 1, wherein the second column has a width or diameter at its intended operational waterline that is larger than the width or diameter of each of the first and third columns at their corresponding intended operational waterlines.

5. The hull structure according to claim 1, wherein the hull structure is provided with motion damping water entrapment plates arranged beneath an operational waterline of the hull structure given by the operational waterlines of the first, second and third columns.

6. The hull structure according to claim 5, wherein the water entrapment plates have a height or thickness that is less than half of the height or thickness of the first and second pontoon structures.

7. The hull structure according to claim 5, wherein the water entrapment plates comprise a first water entrapment plate arranged at the first column and a further or third water entrapment plate arranged at the third column.

8. The hull structure according to claim 7, wherein the first water entrapment plate is arranged on a side of the first column that faces away from the second column or away from the third column but not on a side of the first column that faces the third column, and wherein the further or third water entrapment plate is arranged on a side of the third column that faces away from the second column or away from the first column but not on a side of the third column that faces the first column.

9. The hull structure according to claim 1, wherein the water entrapment plates comprise a second water entrapment plate arranged at the second column.

10. The hull structure according to claim 9, wherein the second water entrapment plate is arranged on an inside the of second column between the first and second pontoon structures.

11. The hull structure according to claim 10, wherein the second column is provided with a recess adapted to receive the second water entrapment plate so as to allow close stowing of at least two hull structures according to claim 10 side by side with the second column of a first hull structure located between the pontoon structures of an adjacent second hull structure.

12. The hull structure according to claim 1, wherein the hull structure exhibits a longitudinal axis extending horizontally through a centroid of the second column and a point halfway between centroids of the first and third columns,
wherein a longitudinal center of flotation (LCF) of the hull structure is a centroid of the operational waterplane areas of the first, second and third column,
wherein a longitudinal center of equivalent mass (LCEM) of the hull structure is given by:
$$L C E M = ( {A}_{PS} \cdot {X}_{PS} + 0.5 \cdot {A}_{HP} \cdot {X}_{HP} ) / ( {A}_{PS} + 0.5 \cdot {A}_{HP} ) ,$$
where
A_{PS}=total horizontally projected area of the first and second pontoon structures,
X_{PS}=centroid of the A_{PS},
A_{HP}=total horizontally projected area of any motion damping water entrapment plates arranged onto the hull structure, and
X_{HP}=centroid of the A_{HP},
wherein the hull structure is arranged such that a first distance between the LCF and the LCEM along the longitudinal axis of the hull structure is <10%, or <5% or <3%, of a second distance between the centroid of the second column and the point halfway between the centroids of the first and third columns.

13. The hull structure according to claim 1, wherein the hull structure is arranged so as to exhibit:
i) a first angle in the horizontal plane between a central longitudinal axis of the first pontoon structure and a central longitudinal axis of the second pontoon structure; and
ii) a second angle in the horizontal plane between a) a first imaginary line between a central point of the first stabilizing column and a central point of the second stabilizing column and b) a second imaginary line between the central point of the second stabilizing column and a central point of the third stabilizing column.

14. The hull structure according to claim 13, wherein the second angle is in the interval 55-90°, preferably 60-80°.

15. The hull structure according to claim 13, wherein the second angle is larger than the first angle.

16. A hull structure for a semi-submersible wind power turbine platform, the hull structure comprising:
first, second and third buoyant stabilizing extending in a substantially vertical direction; and
first and second elongated submersible buoyant pontoon structures extending in a substantially horizontal direction;
wherein the first pontoon structure extends between and connects the first and the second column, wherein the first pontoon structure is connected to a lower part of each of the first and second columns;
wherein the second pontoon structure extends between and connects the second and the third column, wherein the second pontoon structure is connected to a lower part of each of the second and third columns;
wherein the first and second pontoon structures are arranged in a V-shape in the horizontal plane with the first and second pontoon structures forming legs in the V-shape and with the second column located where the legs meet;
wherein each of the first, second and third columns has an intended operational waterline at least approximately corresponding to a water surface when the hull structure is set in an operational state with the first and second pontoon structures submerged beneath the water surface and with the first, second and third columns extending through the water surface,
wherein each of the first, second and third column has a cross sectional area at its intended operational waterline defining an operational waterplane area of each of the columns when the hull structure is set in the operational state,
wherein the hull structure exhibits a longitudinal axis extending horizontally through a centroid of the second column and a point halfway between centroids of the first and third columns,
wherein a longitudinal center of flotation (LCF) of the hull structure is a centroid of the operational waterplane areas of the first, second and third column,
wherein a longitudinal center of equivalent mass (LCEM) of the hull structure is given by:
$$L C E M = ( {A}_{PS} \cdot {X}_{PS} + 0.5 \cdot {A}_{HP} \cdot {X}_{HP} ) / ( {A}_{PS} + 0.5 \cdot {A}_{HP} ) ,$$
where
A_{PS}=total horizontally projected area of the first and second pontoon structures,
X_{PS}=centroid of the A_{PS},
A_{HP}=total horizontally projected area of any motion damping water entrapment plates arranged onto the hull structure, and
X_{HP}=centroid of the A_{HP},
wherein the hull structure is arranged such that a first distance between the LCF and the LCEM along the longitudinal axis of the hull structure is <10%, or <5% or <3%, of a second distance between the centroid of the second column and the point halfway between the centroids of the first and third columns.

17. A hull structure for a semi-submersible wind power turbine platform, wherein the hull structure comprises comprising:
first, second and third buoyant stabilizing columns extending in a substantially vertical direction; and
first and second elongated submersible buoyant pontoon structures extending in a substantially horizontal direction;
wherein the first pontoon structure extends between and connects the first and the second column, wherein the first pontoon structure is connected to a lower part of each of the first and second columns;
wherein the second pontoon structure extends between and connects the second and the third column, wherein the second pontoon structure is connected to a lower part of each of the second and third columns;
wherein the first and second pontoon structures are arranged in a V-shape in the horizontal plane with the first and second pontoon structures forming legs in the V-shape and with the second column located where the legs meet;
wherein each of the first, second and third columns has an intended operational waterline at least approximately corresponding to a water surface when the hull structure is set in an operational state with the first and second pontoon structures submerged beneath the water surface and with the first, second and third columns extending through the water surface,
wherein the hull structure is provided with motion damping water entrapment plates arranged beneath an operational waterline of the hull structure given by the operational waterlines of the first, second and third columns,
wherein the water entrapment plates comprise a first water entrapment plate arranged at the first column and a third water entrapment plate arranged at the third column,
wherein the first water entrapment plate is arranged on a side of the first column that faces away from the second column or away from the third column but not on a side of the first column that faces the third column, and wherein the third water entrapment plate is arranged on a side of the third column that faces away from the second column or away from the first column but not on a side of the third column that faces the first column.

18. The hull structure according to claim 17, wherein the water entrapment plates comprise a second water entrapment plate arranged at the second column, and wherein the second water entrapment plate is arranged on an inside of second column between the first and second pontoon structures.

19. The hull structure according to claim 17, wherein the water entrapment plates have a height or thickness that is less than half of the height or thickness of the first and second pontoon structures.

20. The hull structure according to claim 17, wherein each of the first, second and third columns has a cross sectional area at its intended operational waterline defining an operational waterplane area of each of the columns when the hull structure is set in the operational state,
wherein the hull structure exhibits a longitudinal axis extending horizontally through a centroid of the second column and a point halfway between centroids of the first and third columns,
wherein a longitudinal center of flotation (LCF) of the hull structure is a centroid of the operational waterplane areas of the first, second and third column,
wherein a longitudinal center of equivalent mass (LCEM) of the hull structure is given by:
$$L C E M = ( {A}_{PS} \cdot {X}_{PS} + 0.5 \cdot {A}_{HP} \cdot {X}_{HP} ) / ( {A}_{PS} + 0.5 \cdot {A}_{HP} ) ,$$
where
A_{PS}=total horizontally projected area of the first and second pontoon structures,
X_{PS}=centroid of the A_{PS},
A_{HP}=total horizontally projected area of the motion damping water entrapment plates, and
X_{HP}=centroid of the A_{HP},
wherein the hull structure is arranged such that a first distance between the LCF and the LCEM along the longitudinal axis of the hull structure is <10%, or <5% or <3%, of a second distance between the centroid of the second column and the point halfway between the centroids of the first and third columns.
